(19) United States
(12) Patent Application Publication
(10) Pub. No.: US 2012/0096022 A1
(43) Pub. Date: Apr. 19, 2012

(54) TEXT CONTENT SENSITIVE NON-TEXT CHECKER

(75) Inventors: Brent Anderson, Essex Junction, VT (US); Jed Rankin, Essex Junction, VT (US)

(73) Assignee: INTERNATIONAL BUSINESS MACHINES CORPORATION, Armonk, NY (US)

(21) Appl. No.: 12/907,484

(22) Filed: Oct. 19, 2010

(51) Int. Cl. G06F 17/30

(52) U.S. Cl. 707/769; 707/E17.014

(57) ABSTRACT

A document reminder system comprising a data base for storing a predetermined word or sequence of words; a system for scanning displayed content text for said predetermined word or sequence of words and a non text document identified by said word or sequence of words; a module for comparing said displayed content text as it is scanned for a match with said stored predetermined word or sequence of words; a module coupled to a data base of non text content to search for said identified non text document; and a generating module for selectively generating an indicator in the event the non text content is located.

### BACKGROUND

This invention relates generally to electronic messaging (e.g., e-mail, text or instant messaging) and, more particularly, to providing notification that an action referred to in the message is not performed.

A key problem in the management of documents is the timely transmission and receipt of documents such as drawings, contracts, licenses, leases etc. normally sent to a receiving party as an attachment to an e-mail or like electronic message communication.

Numerous document management systems are known in the art that allow a user to identify a document using a variety of fields that are saved in a database and can be searched when a user wishes to retrieve a document pertaining to a particular matter for accessing and attaching to an e-mail. The problem with these systems, however, is that they require external functionality in order to access the document. Using conventional technology requires that the pertinent information be entered into a docketing or calendaring system. The step of entering information into an e-mail, as an attachment takes time and can require significant labor on the part of workers in an organization. Moreover tedious data entry can be redundant and subject to human error. For example, a situation may arise where an electronically transmitted text message having an attachment which can include drawings are, in fact, not included as an attachment to the e-mail, text or IM message by the sender.

Therefore, it would be beneficial to provide a reminder at some time either before the e-mail or message communication is sent or at a designated time after the e-mail or other written communication is sent that the e-mail was sent without the required attachment.

It would also be beneficial to provide a system that seamlessly interfaces with a user's existing e-mail, text or instant messaging system and other software, to provide a simple and effective means of generating reminders, prompting users, tracking responses to the reminders (if any), and furnishing meaningful information about the document, all within a matter of seconds.

Further, it would be beneficial to provide a system that furnishes quick access to the attachment itself, without a need to search for the attachment. It would be further desirable to have a system that not only automatically identifies the attachment, but also furnishes relevant information to refresh the user's recollection or points to the specific section within the attachment that has triggered its inclusion in the e-mail. Having the reminder directly connected to the attachment permits the user to quickly and easily take appropriate action. For example, a contract may specify that a notice of renewal must be sent within a prescribed period of time prior to the expiration of the term of that contract. By being linked into the attachment itself, an extensive review can be avoided.

Electronic mail messages are often used to schedule meetings and to distribute materials that may be useful to the participants in the meeting where the material being distributed is an attachment to the e-mail message. For example, electronic mail may be an efficient way to transmit as one or more attachments, documents to geographically dispersed participants in a teleconference, a video conference and the like. Often, and particularly where the e-mail has more than one attachment, there is the possibility that the e-mail will be sent without all of the attachments,

Electronic mail and documents are continuing to evolve away from being only text based. They are a mix of text, pictures, videos, sound and links. For example, a user may send an electronic mail message with a Power-Point attachment including formatted text, images, and animations. With most interfaces, the techniques for bringing this information into the document as an attachment may be different for each medium which may result in an attachment not becoming a part of the e-mail or written communication/message.

The present invention is directed to addressing the effects of the problems set forth above.

### SUMMARY

In one aspect of the invention, there is disclosed a method of using text content in an e-mail for providing notification, either actively or passively, while the e-mail is being typed, or after it has been typed but before it is sent that an action referred to in the text of the e-mail is not actually performed. Specifically, this may be the case where an attachment is referred to, but not yet attached.

In another aspect of the invention, there is disclosed a method of using text content in an e-mail being prepared that a document referred to in the text of the e-mail exists in the system and can be added to the e-mail as an attachment.

In another aspect of the invention, there is disclosed a method of using text content in an e-mail for providing notification that material exists in the system which relates to the text content and is being added to the e-mail as an attachment.

In another aspect of the invention, there is disclosed a method of using text content in an e-mail for providing notification that a document referred to in the e-mail is not included in the e-mail or is not an attachment to the e-mail.

In another aspect of the invention, there is disclosed a method of validating that a follow up activity included in the text content of an e-mail has been performed.

In an embodiment there is disclosed a document reminder system including:

a data base for storing a predetermined word or sequence of words;

a system for scanning displayed content text for the predetermined word or sequence of words and a non text document identified by the word or sequence of words;

a module for comparing said displayed content text as it is scanned for a match with the stored predetermined word or sequence of words;

a module coupled to a data base of non text content to search for the identified non text document; and

a generating module for selectively generating an indicator in the event the non text content is located.

In another embodiment there is disclosed a document reminder method including:

storing a predetermined word or sequence of words in a data base;

scanning displayed content text for the predetermined word or sequence of words and a non text document identified by the word or sequence of words;

comparing the displayed content text as it is scanned for a match with the stored predetermined word or sequence of words;

searching a data base of non text content to for the identified non text document; and

selectively generating an indicator in the event the non text content is located.

### BRIEF DESCRIPTION OF THE DRAWINGS

The invention may be understood by reference to the following description taken in conjunction with the accompanying drawings, in which like reference numerals identify like elements, and in which:

FIG. 1 illustrates a system for practicing one or more embodiments of the present invention;

FIG. 2 shows one embodiment of an e-mail that may be stored by an e-mail management module;

FIG. 3 illustrates an alternative embodiment of a system that may implement one or more embodiments of the present invention;

FIG. 4 illustrates an embodiment of a method for providing notification that an attachment has not been added to an e-mail or like electronic message communication;

FIG. 5 illustrates another embodiment of a method for providing a notification that an attachment has not been added to an e-mail; and

FIG. 6 shows a block diagram of a processor based device configured for implementing the methods in accordance with the principles of the invention.

### DETAILED DESCRIPTION

As described in detail below, the present invention provides for accessing text content in an e-mail for providing notification that an action referred to in an e-mail or like communication, e.g., text or instant message, etc. is not performed, e.g., a referred to attachment included in the e-mail is not attached.

For example, in one embodiment of the invention, the text content of the body of an e-mail is checked for one or more words that indicates that a document, such as a drawing or the like is an attachment to the e-mail and verifies that the e-mail it is attached. If the attachment can not be verified, an indicator is generated to alert the user that the e-mail requires an attachment. In an alternative embodiment where an attachment is to be added to an e-mail at a future time such as, for example within one hour, at the close of business, etc., validation that the attachment was made to the e-mail within the specified interval of time can be provided.

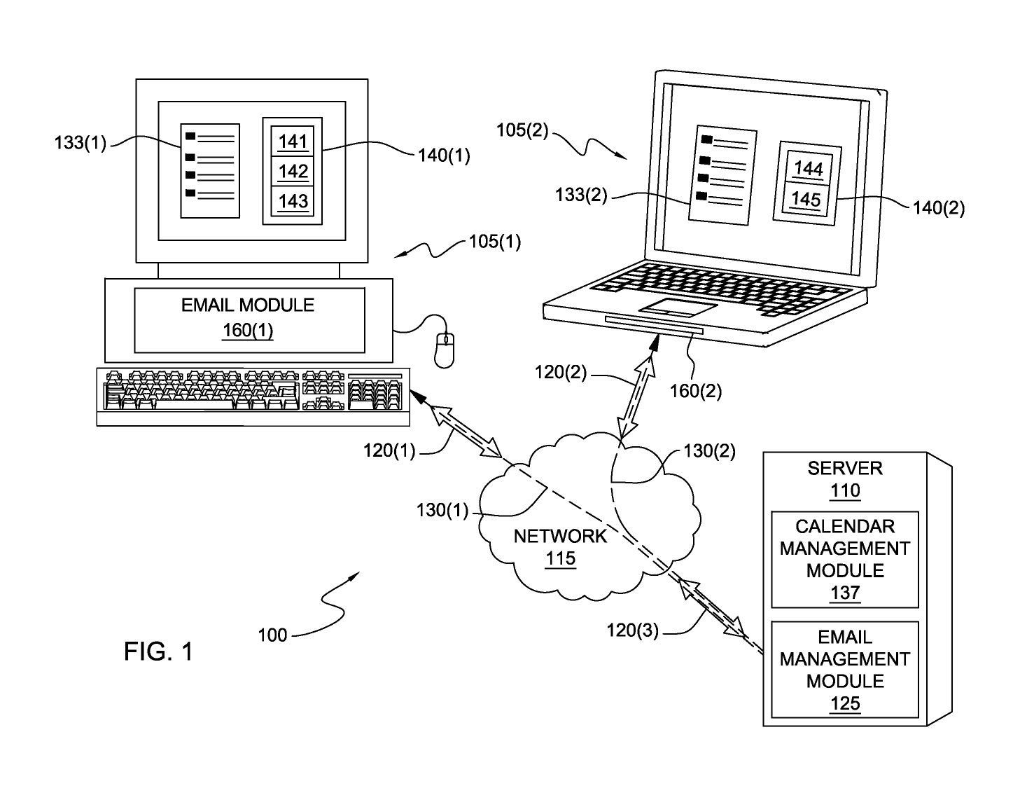

Referring to FIG. 1, there is illustrates a system 100 for practicing one or more embodiments of the present invention. In particular, FIG. 1 illustrates an embodiment that includes a plurality of processor-based devices 105(1-2) coupled to a server 110 by a network 115. The processor-based device 105(1) is a desktop computer and the processor-based device 105(2) is a laptop computer, although in other embodiments, these processor-based devices 105(1-2) may be any desirable type of computer, pervasive digital device (e.g., PDA), cellular telephone, and the like.

The server 110 may be one form of a processor-based device that can be accessed over the network 115. The server 110 may be capable of performing tasks such as receiving, queuing, storing, and/or distributing e-mails to one or more users and may be a conventional e-mail server, such as a Microsoft® Exchange Server. The functionality of the server 110 is not described in detail as these devices and/or features are well known to persons of ordinary skill in the art.

In the embodiment illustrated in FIG. 1, the processor-based devices 105(1-2) and the server 110 are communicatively coupled to the network 115 over one or more communications links 120(1-3). In various alternative embodiments, the links 120(1-3) may be one or more of infrared links, wireless local area network (LAN) links, wired LAN connections such as Ethernet connections, cellular network links, circuit board traces, wires, cables, radio frequency links, satellite links, and the like. Moreover, any desirable protocol may be used for communications between the processor-based devices 105(1-2) and the server 110 via the network 115. For example, a transmission control protocol/Internet protocol (TCP/IP), a user datagram protocol/Internet protocol (UDP/IP), a file transfer protocol or trivial file transfer protocol (FTP/TFTP), and the like may be used.

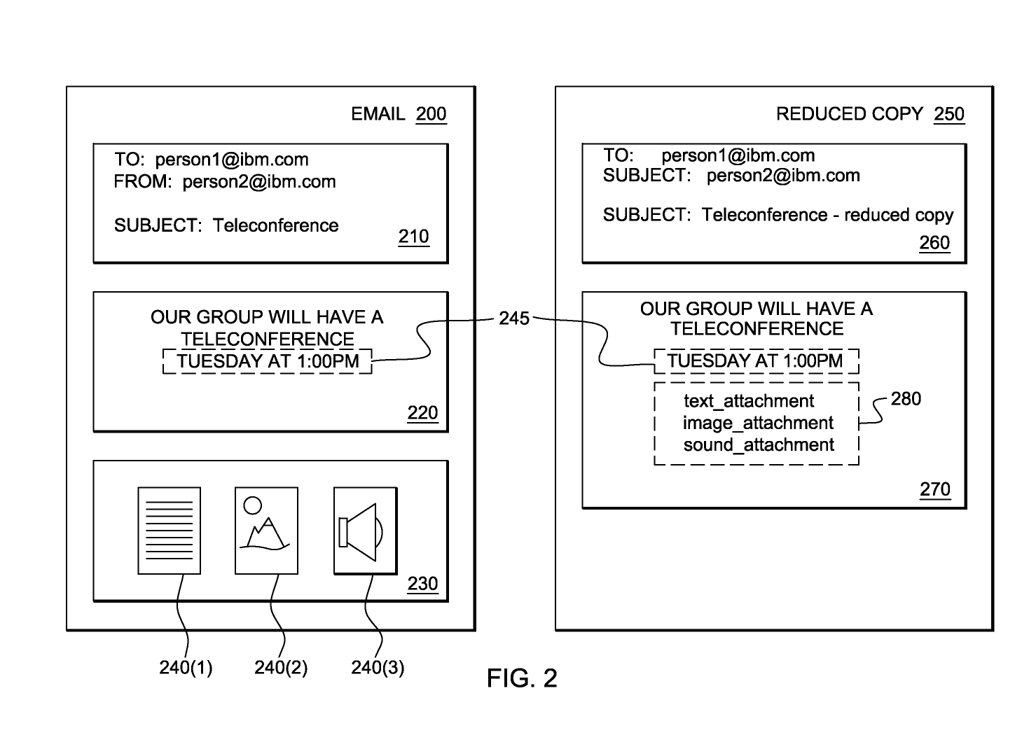

The server 110 includes an e-mail management module 125, which may process (e.g. receive, queue, store, and/or deliver) one or more electronic mail messages, hereinafter referred to as e-mails, in accordance with common usage in the art. One form of an e-mail 200 that may be processed by the e-mail management module 125 is shown in FIG. 2. The e-mail 200 can include a header 210, a body 220, and one or more attachments 230. The header 210 generally includes information indicative of one or more designated recipients of the e-mail (i.e. person1@ibm.com), the sender or distributor (i.e. person2@ibm.com), and the subject of the e-mail 200 (i.e. Teleconference). The body 220 generally includes the message being conveyed. For example, in the e-mail 200, the body includes a text string, “Our group will have a teleconference.”

The e-mail message 200 shown in FIG. 2 also includes attachments 240(1-3) that may include a text document 240(1), a graphics file 240(2), and an audio file 240(3). However, persons of ordinary skill in the art will appreciate that any desirable number of files, as well as any desirable type and/or format of file, may be attached to the e-mail 200. Additionally, it should be appreciated that the e-mail 200 illustrated in FIG. 2 is exemplary in nature, and that it may include more, fewer, or different types of attachments.

The e-mail 200 may also have an associated time field 245 that includes an indication of a time associated with the e-mail 200. As illustrated, the field 245 includes a day (Tuesday) and a time (1:00 pm) which may correspond to, for example, a scheduled day and time of a meeting. In alternative embodiments, any desirable format for the field 245 may be used and the e-mail 200 may include an indication of an event associated with the e-mail 200, such as the teleconference indicated in the exemplary e-mail 200 shown in FIG. 2.

Returning to FIG. 1, the e-mail 200 may be associated with one or more calendars 133(1-2), and a calendar management module 137. For example, the header 141, body 142, and attachments 143 may be associated with an entry in one or more of the calendars 133(1-2), and the calendar management module 137. The calendars 133(1-2), and module 137 may be the calendars 133(1-2) maintained on the processor based devices 105(1-2), respectively, and/or the calendar management module 137 maintained on the server 110. For example, the calendars 133(1-2) may be provided by copies of Microsoft Outlook® running on the processor based devices 105(1-2). However, any desirable scheduling and/or calendar tool may be used.

The e-mail management module 125 on the server 110 may provide the e-mail 200, or a selected portion, to one or more designated recipients, which are assumed to be the users of the processor-based systems 105(1-2). Thus, the e-mail management module 125 provides at least the selected portion of the e-mail 200 to the processor-based devices 105(1-2). However, any number of users of any desirable processor-based systems may be designated as the recipients and may receive portions of the e-mail 200 provided by the e-mail management module 125. The portion of the e-mail 200 transmitted to the user of each processor-based device 105(1) and 105(2) is hereinafter designated in FIG. 1 by reference numbers 140(1) and 140(2), respectively.

The e-mail management module 125 may provide the e-mail 200 via a variety of communication paths 130(1-2). The e-mail management module 125 may transmit a selected portion of the e-mail 200 (designated by reference number 140(1)) to the processor-based device 105(1) along the communication path 130(1) which may include link 120(3), network 115, and link 120(1). The e-mail management module 125 may also transmit a selected portion of the e-mail 200 (designated by reference number 140(2)) to the processor-based device 105(2) along communication path 130(2), which may include link 120(3), network 115, and link 120(2). Communications paths 130(1-2) may include one or more intermediate gateways (not shown), routers (not shown), and the like.

The data transfer rate along the communication paths 130(1-2) may vary by many orders of magnitude. For example, the communication path 130(1) may consist of a dedicated T-3 connection that may provide data at a transfer rate as high as 40 megabits per second. Accordingly, even if the attachments 240(1-3) attached to the e-mail 200 are large, e.g. 100 MB, the total time required to transfer the copy 140(1) may remain comparatively low, e.g. a few seconds in the case of the 100 MB attachments 240(1-3). In contrast, the communication path 130(2) may include a dial-up connection, such as the link 120(2), which may transfer data at a much lower rate. Thus, a user may have to wait several hours for the 100 MB attachments 240(1-3) to be transferred via the communication path 130(2). The long transfer time may inconvenience the user, particularly if the user does not wish to see the attachments 240(1-3), but does want to see one or more e-mails that may be transferred subsequently from the server 110.

FIG. 2 shows an embodiment of a reduced copy 250, which includes a header 260 and a body 270. The header 260 includes information indicative of the recipients of the e-mail (i.e. person1@ibm.com), the sender (i.e. person2@ibm.com), and the subject of the e-mail 200 (i.e. Teleconference—reduced copy). The body 270 includes a text string, “Our group will have a teleconference.” In addition, the body 270 may also include an additional text string 280 that indicates the contents of the attachments 240(1-3). The additional text string 280 includes the strings “text_attachment,” “image_attachment,” and “audio_attachment.” Although not shown in FIG. 2, the additional text string 280 may include other information, such as an estimated size of the attachments 240(1-3), the estimated transfer time for the entire e-mail 200 and/or for the attachments 240(1-3), and the like.

Returning to FIG. 1, the e-mail management module 125 may queue and/or store the e-mail 200. For example, if the reduced copy 140(2) has been transmitted to the processor-based device 105(2), the e-mail 200 may be queued and/or stored until a higher speed connection is available. The e-mail management module 125 may also provide a notification to the sender indicating that the attachment portion of the e-mail 200 has not been delivered to the intended recipient.

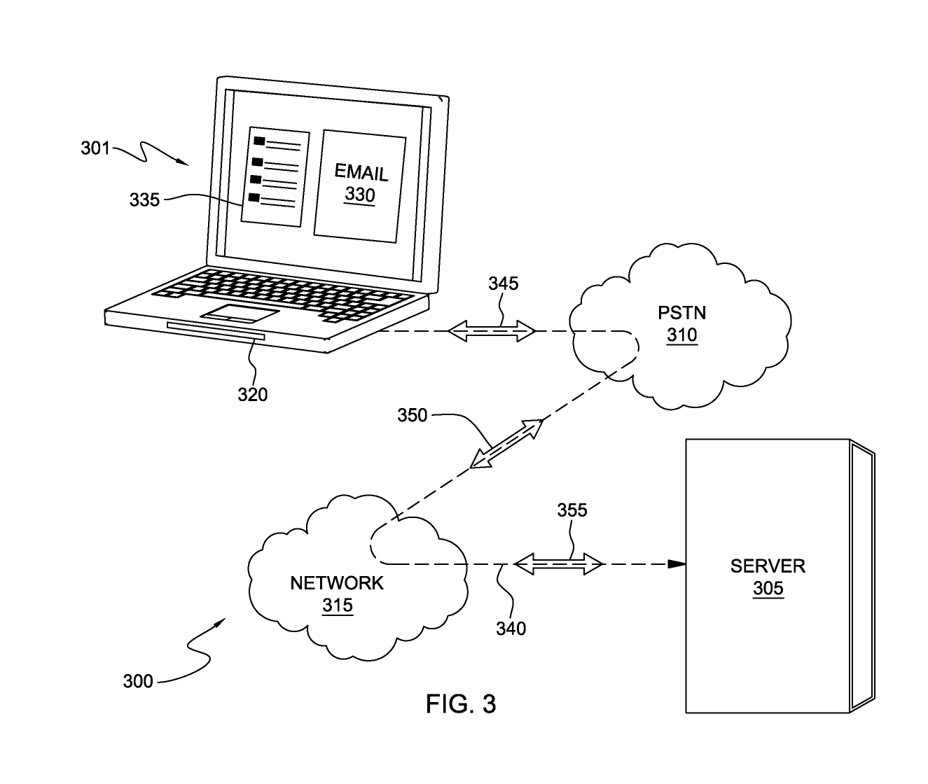

FIG. 3 illustrates a system 300 that may implement one or more alternative embodiments of the present invention. In FIG. 3, a processor-based device 301 is communicatively coupled to a server 305 by a public switched telephone network (PSTN) 310 and a network 315. Thus, the transmission of e-mails from the processor-based device 301 to the server 305 may be implemented in the alternative embodiment shown in FIG. 3. In various alternative embodiments, the processor-based device 301 may allow one or more users to create and/or send an e-mail 330 or the processor-based device 301 may be an automated mail server that may create and/or send the e-mail 330. The e-mail 330 may also have an associated time, such as the associated time indicated in the associated time field 245 shown in FIG. 2. As noted above, e-mail 330 may be associated with a calendar 335 using the associated time.

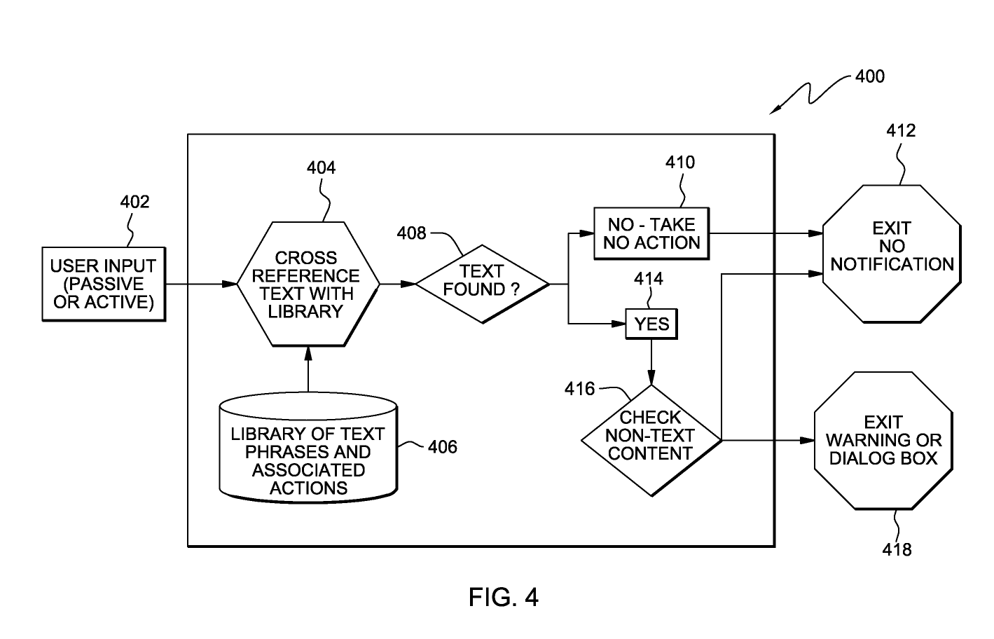

FIG. 4 illustrates an embodiment of the method of 400 for determining if text content in an e-mail contains at least one word that indicates that the e-mail has an attachment and then takes appropriate action. Initially, the text content of an e-mail is checked for either non-text or text content where the text content can be at least one word that indicates that the e-mail has an attachment. The check can be performed either real time while the e-mail is being typed or during the final stage of the e-mail document preparation. The method of checking can be similar to a spell checker in that notification is provide that an attachment has not been added to the e-mail as the e-mail is being typed. An identifier to indicate that the e-mail refers to an attachment can be either passive by using underscoring and/or bold type, or it can be active by generating a dialog box.

For example, an e-mail document is scanned for key words of phrases such as “included”, “the figure below”, “Shown below” or the like, and verifies that an attachment does exist. If no key word of phrase is found, or the e-mail has an attachment, no identifier is generated. If, however, a key word or phrase is located, a passive or active indicator is generated. The indicator can be the highlighting of the word of phrase in the e-mail, or it can be a pop up window that may require active dismissal by either clicking on the pop up window or by attaching the identified document to the e-mail. As an alternative, a flag can be automatically inserted into the e-mail as a reminder to the user that the e-mail requires an attachment. The user can then decide to immediately add the document as an attachment to the e-mail, or add the document at some time before sending the e-mail, or delete the indicator at any time prior to sending the e-mail.

Referring to FIG. 4, as an e-mail is being typed, the content text of the e-mail is scanned at 402. The scanned text of the e-mail is cross referenced at 404 with a library of text phrases located at 406. The library also contains associated actions, some of which are implemented when the scanned text contains a word or phrase which matches a word or phrase in the library, and others which are implemented when there is no match. A comparison of the e-mail text with the contents in the library is made at 408. If a match is not found, a decision to take no action is made at 410 and a notification indicator is not generated at 412. Returning to 408 where the comparison of the typed text with the contents in the library is made, if a match is found, 414, a search is made for at least one document such as a drawing, recording etc., which relates to the word or phrase. If the search is successful, the found document becomes an attachment to the e-mail being typed and no notification indicator is generated at 412. If, however, the search is not successful and at least one document is not found, then at 418 a notification indicator is generated at 418. The notification indicator can be underscoring or highlighting text in the e-mail, or generating a flag.

The automatic attachment of a document to an e-mail or the generation of an indictor that a document has not been found or attached to the e-mail as it is being typed is not limited to e-mails. In addition to e-mail, the invention can be used with documents, text messages etc., and to look for attached files, embedded images, dynamic links, etc.

The invention can be configured to operate with a single e-mail, or it can be configured to operate with any system which references and/or locates associated material. In an embodiment where an e-mail includes a phrase such as “I will forward the relevant information . . . ”, after the e-mail is sent an interface can appear to assist the user on following through on forwarding and/or providing the additional information. In an embodiment where the text of a document or an e-mail contains a reference to an earlier e-mail, the system can check that there was an earlier e-mail and can make that earlier e-mail an attachment.

In still another embodiment where an e-mail contains a phrase such as or similar to “see attached”, the system can generate a dialog box which can be displayed and attached to the e-mail. In still another embodiment, the system will not allow the e-mail to be sent until the user takes some action with regard to the dialog box.

In another embodiment the system triggers secondary activities and creates a temporal activity or limit. For example, the system can validate that follow up activity has been completed within a set time frame such as, for example, within one hour, at the close of business, etc. In another embodiment, the system creates a calendar entry as a reminder to do follow up activity. In another embodiment the system creates a “to do” item or list based of text in the e-mail or in a document. In another embodiment the system can scan a word document for action words which are then used to dynamically create and/or populate a “to do” list.

For example, the text of a e-mail includes the phrase “I will schedule a meeting . . . ”. The system can either generate one or more dialog boxes as described above; create a time limited reminder as a prompt if a meeting is not set up with the e-mail recipient within a predetermined time frame; and/or create a “to do” reminder.

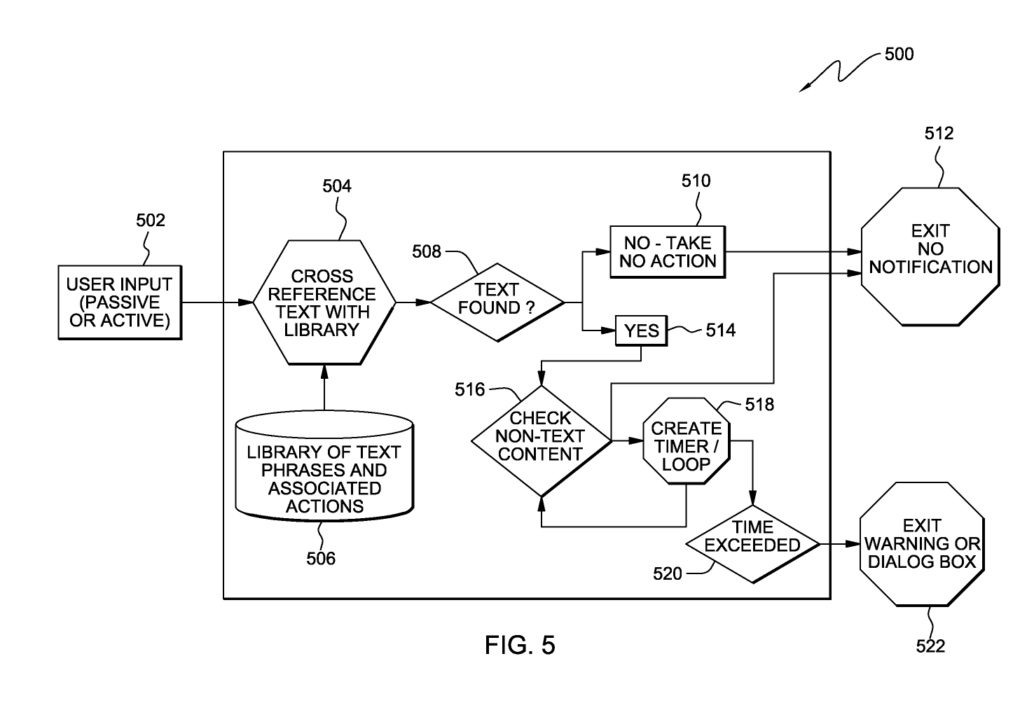

FIG. 5 illustrates another embodiment of a method 500 for determining if text content in an e-mail contains at least one word that indicates the e-mail has an attachment and then takes appropriate action if the e-mail does not have an attachment. Initially, the text content of an e-mail is checked for either non-text or text content where the text content can be at least one word that indicates the e-mail has an attachment. The check can be performed either real time or during the final stage of the e-mail preparation and the method of checking can be similar to a spell checker for providing a notification that an attachment has not been added to the e-mail. An identifier to indicate that the e-mail refers to an attachment can be either passive by using underscoring and/or bold type, or it can be active by generating a dialog box. As the e-mail is being typed, the content text of the e-mail is scanned at 502. The scanned text of the e-mail is cross referenced at 504 with a library of text phrases located at 506. The library also contains associated actions, some of which are implemented when the scanned text contains a word or phrase which matches a word of phrase in the library, and others that are implemented when there is no match. A comparison of the typed text in the e-mail with the contents in the library is made at 508. If a match is not found, a decision to take no action is made at 510 and a notification indicator is not generated at 512. Returning to where the comparison of the typed text with the contents in the library is made at 508, if a match is found, 514, a search is made at 516 for at least one document such as a drawing, an e-mail, a recording etc., which is identified by the word or phrase. If the search is successful, the found document, the drawing or recording, can become an attachment to the e-mail being typed and a notification indicator is not generated at 512. If, however, the search is not successful and at least one document is not found, or a document has been located but not attached to the e-mail, then at 518 a time is set for the located document to be attached to the e-mail. If the document is attached to the e-mail within the time designated, a notification indicator is not generated at 512. If however the time designated for making the attachment expires 520 before an attachment is made, a notification indicator is generated at 522. The notification indicator can be underscoring, highlighting text, or generating a flag.

Referring to FIG. 3, the processor-based device 301 includes an e-mail management module 320 that may provide a copy of the e-mail 330 to the server 305. For example, the e-mail management module 320 may transmit at least a portion of the e-mail 330 to the server 310 along the communication path 340, which may include link 345, public switched telephone network 310, link 350, network 315, and link 355. As discussed above, the data transfer rate along the communication path 340 may vary by many orders of magnitude. For example, if the processor-based device 301 is linked to the public switched telephone network (PSTN) 310 via a 14.4 KB modem (not shown), it may not be desirable to transmit a 100 MB attachment (not shown) to the server 305. Thus, the e-mail management module 320 may only transmit a portion of the e-mail 330 along the communication path 340.

After transmitting the portion of the e-mail 330 along the communication path 340, the e-mail management module 320 may queue and/or store the e-mail 330 until a faster connection is available. For example, a user may later connect the processor-based device 301 to the network 315 via a higher-speed connection, such as an Ethernet, and then the e-mail management module 320 may transmit the e-mail 330 using the higher speed connection. The e-mail management module 320 may also provide a notification indicating that a portion of the e-mail 330 has not been delivered to the intended recipient, i.e. the server 305. For example, the e-mail management module 320 may determine that the current time is approaching the associated time 245, i.e. the time of the scheduled teleconference. Depending on how close the current time is to the associated time 245, the e-mail management module 320 may provide notifications more frequently and with higher urgency.

In response to the notification, the undelivered e-mail 330 may be uploaded to the server 305. The notification may include giving a user an option to upload the e-mail 330 and the user may request that the e-mail 330 be uploaded in response to the notification. The e-mail management module 320 may upload substantially all of the e-mail 330 to the server 305.

One or more of the e-mails, or portions thereof, may be associated with a time and/or a scheduled event. For example, a user may schedule a meeting and distribute materials to the meeting participants in an e-mail, which may include one or more attachments. A meeting notification may also be provided to the users who may participate in the meeting. However, not all of the e-mails and/or the attachments may be provided to the users. Thus, a user may want to transfer undelivered portions of the associated e-mail messages, such as the portions that may be queued and/or stored on a server and/or other processor-based device, prior to the associated time and/or event.

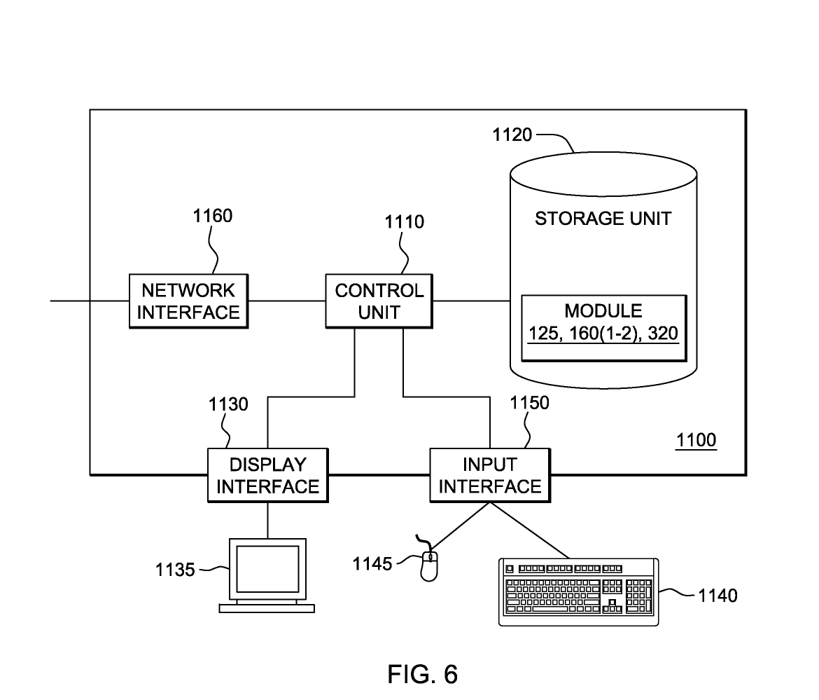

FIG. 6 shows a block diagram of a processor-based device 1100, in accordance with one embodiment of the present invention. The processor-based device 1100 may represent portions of the processor-based devices 105(1-2), 301 and/or the servers 110, 305. The device 1100, depending on the particular implementation, is configured with appropriate software configuration, including the e-mail management module 125 or the e-mail modules 160(1-2) of FIG. 1, or with the e-mail management module 320 in the system 300 of FIG. 3.

The device 1100 comprises a control unit 1110, which may be a processor that is communicatively coupled to a storage unit 1120. The software installed in the storage unit 1120 may depend on the features to be performed by the device 1100. For example, if the device 1100 represents one of the processor-based devices 105(1-2), 110, 301, 305 then the storage unit 1120 may include the e-mail management modules 125, 320, as well as the e-mail modules 160(1-2). The e-mail management modules 125, 320 and the e-mail modules 160(1-2) may be operable by the control unit 1110. Although not shown, it should be appreciated that an operating system, such as Windows®, Disk Operating System®, Unix®, OS/2®, Linux®, MAC OS®, or the like, may be stored on the storage unit 1120 and be operable by the control unit 1110. The storage unit 1120 may also include device drivers for the various hardware components of the device 1100.

The device 1100 includes a display interface 1130 which may display information on a display device 1135 via the display interface 1130. A user may input information using an input device, such as a keyboard 1140 and/or a mouse 1145, through an input interface 1150. The control unit 1110 is coupled to a network interface 1160, which may be adapted to receive, for example, a local area network card. The network interface 1160 may be a Universal Serial Bus interface or an interface for wireless communications. The device 1100 communicates with other devices through the network interface 1160. Although not shown, associated with the network interface 1160 may be a network protocol stack, with one example being a UDP/IP or a TCP/IP stack where both inbound and outbound packets may be passed through the network interface 1160 and the network protocol stack.

It should be appreciated that the block diagram of the device 1100 of FIG. 6 is exemplary in nature and that in alternative embodiments, additional, fewer, or different components may be employed without deviating from the spirit and scope of the invention. For example, if the device 1100 is a computer, it may include additional components such as a system bus or an I/O bus. In other embodiments, the various elements of the device 1100 may be interconnected using various buses and controllers. Similarly, depending on the implementation, the device 1100 may be constructed with other desirable variations without deviating from the spirit and scope of the present invention.

The various system layers, routines, or modules may be operable on control units, such as the control unit 1110. The control unit 1110 may include a microprocessor, a microcontroller, a digital signal processor, a processor card (including one or more microprocessors or controllers), or other control or computing devices. The storage devices referred to may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed or removable disks; other magnetic media including tape; and optical media such as compact disks (CDs) or digital video disks (DVDs). Instructions that make up the various software layers, routines, or modules in the various systems may be stored in respective storage devices. The instructions when invoked by a respective control unit 1110 cause the corresponding system to perform programmed acts.

The various embodiments disclosed above may be modified and practiced in different but equivalent manners apparent to those skilled in the art having the benefit of the teachings herein. Furthermore, no limitations are intended to the details of construction or design herein shown, other than as described in the claims below. It is therefore evident that the embodiments disclosed above may be altered or modified and all such variations are considered within the scope and spirit of the invention.

What is claimed is:

1. A document reminder system comprising:
a memory for storing a predetermined word or sequence of words;
a processor in communications with the memory, wherein the reminder system is capable of performing a method comprising:
storing a predetermined word or sequence of words in said memory;
scanning displayed content text for said predetermined word or sequence of words and a non text document identified by said word or sequence of words;
comparing said displayed content text as it is scanned for a match with said stored predetermined word or sequence of words;
searching a data base of non text content to for said identified non text document; and
selectively generating an indicator in the event the non text content is located.

2. The system of claim 1 wherein said displayed content text comprises content text in the body of an e-mail message, text message or instant message.

3. The system of claim 2 wherein said generated indicator comprises text that is underscored and/or bold.

4. The system of claim 2 wherein no indicator is generated when said non-text content is not located.

5. The system of claim 3 further comprising generating text that is underscored and/or bold upon locating said identified non text document.

6. The system of claim 5 further comprising ending generating text that is underscored and/or bold when said identified non text document is attached to said e-mail.

7. The system of claim 5 further comprising preventing, by a server device coupled to said system, the sending of said e-mail while said text is underscored and/or bold.

8. The system of claim 1 wherein said generated indicator further comprises a to do list.

9. The system of claim 1 wherein said generated indicator further comprises a calendar entry as a reminder to do a follow up activity.

10. A document reminder method comprising:
storing a predetermined word or sequence of words in a data base;
scanning displayed content text for said predetermined word or sequence of words and a non text document identified by said word or sequence of words;
comparing said displayed content text as it is scanned for a match with said stored predetermined word or sequence of words;
searching a data base of non text content to for said identified non text document; and
selectively generating an indicator in the event the non text content is located,
wherein a processor unit runs a program to execute one or more of said storing, scanning, comparing, searching and generating.

11. The method of claim 10 wherein said scanning of displayed content text comprises content text in the body of an e-mail message, text message or instant message.

12. The method of claim 11 wherein said indicator selectively generated by said generating module comprises underscored and/or bold text.

13. The method of claim 11 wherein said generating module indicator generates no indicator when said non-text content is not located.

14. The method of claim 12 wherein said generating module further comprises generating text that is underscored and/or bold upon locating said identified non text document.

15. The method of claim 14 wherein said generating module further comprises ending generating underscored and/or bold text when said identified non text document is attached to said e-mail.

16. The method of claim 14 further comprises preventing the sending of said e-mail by a server while said text is underscored and/or bold.

17. The method of claim 10 wherein said indicator generated by said generating module further comprises a to-do list.

18. The method of claim 10 wherein said indicator generated by said generating module further comprises a calendar entry as a reminder to do a follow up activity.

19. A computer program product for providing document reminders, the computer program product comprising:
a storage medium readable by a processing circuit and storing instructions for execution by the processing circuit for performing a method comprising:
storing a predetermined word or sequence of words in a data base;
scanning displayed content text for said predetermined word or sequence of words and a non text document identified by said word or sequence of words;
comparing said displayed content text as it is scanned for a match with said stored predetermined word or sequence of words;
searching a data base of non text content to for said identified non text document; and
selectively generating an indicator in the event the non text content is located.
